(19) United States
(12) Patent Application Publication
(10) Pub. No.: US 2025/0174941 A1
(43) Pub. Date: May 29, 2025

(54) CONNECTOR

(71) Applicant: SUMITOMO WIRING SYSTEMS, LTD., Mie (JP)

(72) Inventor: Yuta INOUE, Mie (JP)

(21) Appl. No.: 18/954,909

(22) Filed: Nov. 21, 2024

(30) Foreign Application Priority Data
Nov. 29, 2023 (JP) 2023-201515

(51) Int. Cl. H01R 13/639; H01R 13/11; H01R 13/504; H01R 13/629

(52) U.S. Cl. CPC H01R 13/639; H01R 13/111; H01R 13/5045; H01R 13/62916

(57) ABSTRACT

A connector includes a housing having a cavity extending in a front-rear direction, a terminal fitting configured to be accommodated in the cavity, and a retainer movable toward one side in a vertical direction from a partial locking position to a full locking position relative to the housing. The retainer includes at least one insertion portion through which the terminal fitting is insertable, and allows passage of the terminal fitting through the at least one insertion portion at the partial locking position, and restricts dislodgement of the terminal fitting from the cavity at the full locking position. The terminal fitting has a pressing portion formed thereon. The at least one insertion portion includes at least one pressed insertion portion configured to be pressed toward the one side in the vertical direction by the pressing portion at the partial locking position.

### CROSS-REFERENCE TO RELATED APPLICATIONS

This application is based on and claims priority from Japanese Patent Application No. 2023-201515, filed on Nov. 29, 2023, with the Japan Patent Office, the disclosure of which is incorporated herein in its entirety by reference.

### TECHNICAL FIELD

The present disclosure relates to a connector.

### BACKGROUND

The connector disclosed in JP 2021-057213A includes a housing including a contact accommodating space (hereinafter referred to as a cavity), a contact (hereinafter referred to as a terminal fitting), and a retainer. The terminal fitting is inserted to be accommodated in the cavity of the housing. The retainer is mounted to the housing after subsequently to the terminal fitting. As a result of the retainer being mounted to the housing, dislodgement of the terminal fitting from the housing is inhibited. Note that JP 2005-056792A and JP 2013-243011A disclose terminal fittings. JP 2003-007385A discloses a retainer.

### SUMMARY

For JP 2021-057213A, the retainer must be moved to a full locking position by a manual operation (including using a jig or the like) after performing an operation for inserting the terminal fitting into the housing, and there is room for improvement in operability.

Therefore, an object of the present disclosure is to provide a connector that allows for an improvement in the operability of an operation for moving a retainer to a housing.

A connector according to the present disclosure is a connector including: a housing having a cavity extending in a front-rear direction; a terminal fitting configured to be accommodated in the cavity; and a retainer movable toward one side in a vertical direction from a partial locking position to a full locking position relative to the housing, wherein the retainer includes at least one insertion portion through which the terminal fitting is insertable, and configured to allow passage of the terminal fitting through the at least one insertion portion at the partial locking position, and restrict dislodgement of the terminal fitting from the cavity at the full locking position, the terminal fitting has a pressing portion formed thereon, and the at least one insertion portion includes at least one pressed insertion portion configured to be pressed toward the one side in the vertical direction by the pressing portion at the partial locking position, to move the retainer to the full locking position.

According to the present disclosure, it is possible to provide a connector that allows for an improvement in the operability of an operation for moving a retainer to a housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to Embodiment 1.

FIG. 2 is a perspective view of an inner housing of the connector according to Embodiment 1.

FIG. 3 is a side view of a terminal fitting of the connector according to Embodiment 1.

FIG. 4 is an enlarged perspective view of a bottom surface of a retainer mounting hole of the inner housing of the connector according to Embodiment 1.

FIG. 5 is a perspective view of a retainer of the connector according to Embodiment 1.

FIG. 6 is a front view of the retainer of the connector according to Embodiment 1.

FIG. 7 is an enlarged perspective view of a pressed insertion portion of the retainer of the connector according to Embodiment 1.

FIG. 8 is a cross-sectional side view of the connector according to Embodiment 1, showing a state in which the retainer is disposed at a partial locking position relative to a housing.

FIG. 9 is an enlarged transverse sectional view of the connector according to Embodiment 1, showing a portion including a housing lock portion and a pressed insertion portion when the retainer is disposed at the partial locking position relative to the housing.

FIG. 10 is a cross-sectional side view of the connector according to Embodiment 1, shown in a state in which a pressing portion starts to come into contact with a pressed protrusion in the process in which a terminal fitting in the uppermost column is inserted into a cavity.

FIG. 11 is a cross-sectional side view of the connector according to Embodiment 1, showing a state in which all terminal fittings are inserted into cavities, and the retainer is disposed at a full locking position relative to the housing.

FIG. 12 is an enlarged transverse sectional view of the connector according to Embodiment 1, showing a portion including terminal fittings, a housing lock portion, and a pressed insertion portion when the retainer is disposed at the full locking position relative to the housing.

FIG. 13 is a plan view of the connector according to Embodiment 1, showing a state in which distal end portions of a jig start to be mounted to the housing in a state in which the retainer is disposed at the full locking position relative to the housing.

FIG. 14 is a plan view of the connector according to Embodiment 1, showing a state in which the distal end portions of the jig slide on cam portions of the housing, and the retainer has been moved to a complete position relative to the housing.

FIG. 15 is an enlarged transverse sectional view of the connector according to Embodiment 1, showing a portion including terminal fittings, a housing lock portion, and a pressed insertion portion in a state in which the retainer is disposed at the complete position relative to the housing.

FIG. 16 is an enlarged transverse sectional view of the connector according to Embodiment 1, showing a portion where a distal end portion of a stopper portion is fitted and locked to a complete receiving portion in a state in which the retainer is disposed at the complete position relative to the housing.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.

(1) A connector according to the present disclosure is a connector including: a housing having a cavity extending in a front-rear direction; a terminal fitting configured to be accommodated in the cavity; and a retainer movable toward one side in a vertical direction from a partial locking position to a full locking position relative to the housing, wherein the retainer includes at least one insertion portion through which the terminal fitting is insertable, and configured to allow passage of the terminal fitting through the at least one insertion portion at the partial locking position, and restrict dislodgement of the terminal fitting from the cavity at the full locking position, the terminal fitting has a pressing portion formed thereon, and the at least one insertion portion includes at least one pressed insertion portion configured to be pressed toward the one side in the vertical direction by the pressing portion at the partial locking position, to move the retainer to the full locking position.

When the retainer is at the partial locking position, and the distal end portion of the terminal fitting is to pass through the interior of the pressed insertion portion, the pressing portion of the terminal fitting presses the pressed insertion portion of the retainer, and the retainer can be moved from the partial locking position to the full locking position. Accordingly, the retainer can be automatically moved to the full locking position, in conjunction with an operation of inserting the terminal fitting into the housing.

(2) In the connector according to (1) above, it is preferable that the retainer includes a housing lock portion configured to be locked to the housing at the partial locking position, a plurality of the insertion portions are formed in the retainer, and the at least one pressed insertion portion is constituted by the insertion portion located closest to the housing lock portion, among the plurality of the insertion portions.

With the configuration according to (2) above, the pressing force with which the pressing portions press the pressed insertion portion is effectively transmitted to the housing lock portion, and therefore the locking between the housing lock portion and the housing at the partial locking position can be easily released.

(3) In the connector according to (1) or (2) above, it is preferable that a plurality of the insertion portions are formed in the retainer so as to be arranged in the vertical direction, and the at least one pressed insertion portion is constituted by the insertion portion located at an end portion on another side in the vertical direction, among the plurality of the insertion portions.

With the configuration according to (3) above, when successively inserting terminal fittings in the cavities from an end portions on one side in the vertical direction, and inserting the terminal fittings into the cavities located at the end portion on the other side in the vertical direction, the pressed insertion portions can be pressed toward the one side in the vertical direction by the pressing portions of the terminal fittings, thus easily moving the retainer to the full locking position.

(4) In the connector according to any one of (1) to (3) above, it is preferable that a plurality of the insertion portions are formed in the retainer so as to be arranged in a lateral direction, and the at least one pressed insertion portion is constituted by the insertion portions located at left and right end portions, among the plurality of the insertion portions.

With the configuration according to (4) above, the pressing force exerted from the pressing portions to the retainer is exerted in a well-balanced manner on the pressed insertion portions located at left and right end portions of the retainer, and therefore the retainer can be smoothly moved to the full locking position without being inclined.

(5) I the connector according to any one oof (1) to (4) above, it is preferable that, on an inner surface portion, located on the one side in the vertical direction, of an inner surface of the at least one pressed insertion portion, a pressed protrusion protruding toward another side in the vertical direction and configured to come into contact with the pressing portion is formed, and, on an inner surface portion, located on the other side in the vertical direction, of the inner surface of the at least one pressed insertion portion, a recess that is recessed toward the other side in the vertical direction is formed.

With the configuration according to (5) above, when the retainer is moved to the full locking position, the pressing portions of the terminal fittings press the pressed protrusions of the pressed insertion portions. Accordingly, the pressing force exerted from the pressing portions on the retainer can be adjusted by adjusting the protruding dimension and the shape of the pressed protrusions. Even if any of the pressing portions comes into contact with the pressed protrusion, and the terminal fitting is displaced in a direction in which the pressing portion rides on the pressed protrusion, a portion of the displaced terminal fittings can escape into the recess. Accordingly, it is possible to prevent the terminal fitting from coming into contact with the inner surface of the pressed insertion portion.

(6) In the connector according to (5) above, it is preferable that in order for a locking range of the retainer relative to the terminal fitting to be expanded toward one side of the recess in a lateral direction, the retainer is movable toward another side in the lateral direction from the full locking position to the complete position relative to the housing.

There is concern that, due to the presence of the recess, the terminal fitting that has passed through the interior of the pressed insertion portion may not be locked in a stable locking state to the retainer at the full locking position. In this respect, with the configuration according to (6) above, the locking range of the retainer relative to the terminal fitting is increased toward one side of the recess in the lateral direction by the retainer being moved from the full locking position to the complete position. Accordingly, the lateral center of the locking range can be positional displaced from the lateral center of the recess toward the one side in the lateral direction. Consequently, the terminal fitting can be locked to the retainer in a stable locking state at the complete position.

(7) In the connector according to (6) above, it is preferable that the housing includes a cam portion for moving the retainer to the complete position, and the cam portion extends in the front-rear direction, and has a shape that is open forward and is inclined toward the other side in the lateral direction as the cam portion extends rearward.

For example, in the process in which a jig used for a conduction test or the like is mounted to the housing from the front side, the distal end portion of the jig is displaced along the cam portion, whereby the retainer can be moved from the full locking position to the complete position. Accordingly, it is not necessary to perform any special operation for moving the retainer to the complete position, thus ensuring an improvement in the operability.

### Details of Embodiments of the Present Disclosure

Specific examples of the present disclosure will be described below with reference to the drawings. It should be note that the present invention is not limited to these examples, and is intended to include all modifications which fall within the scope of the claims and the meaning and scope of equivalents thereof.

### Embodiment 1

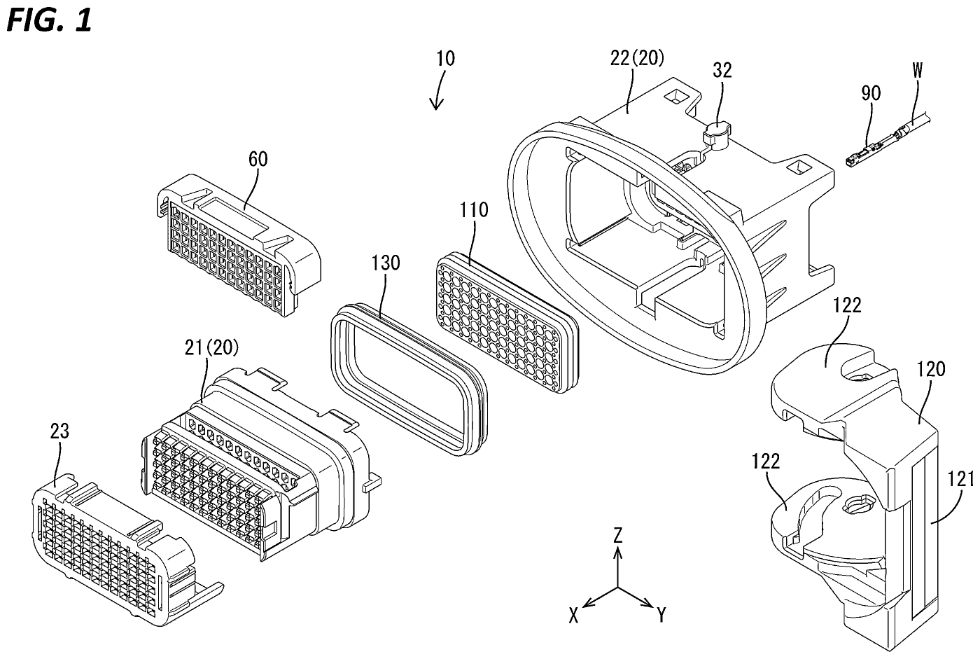

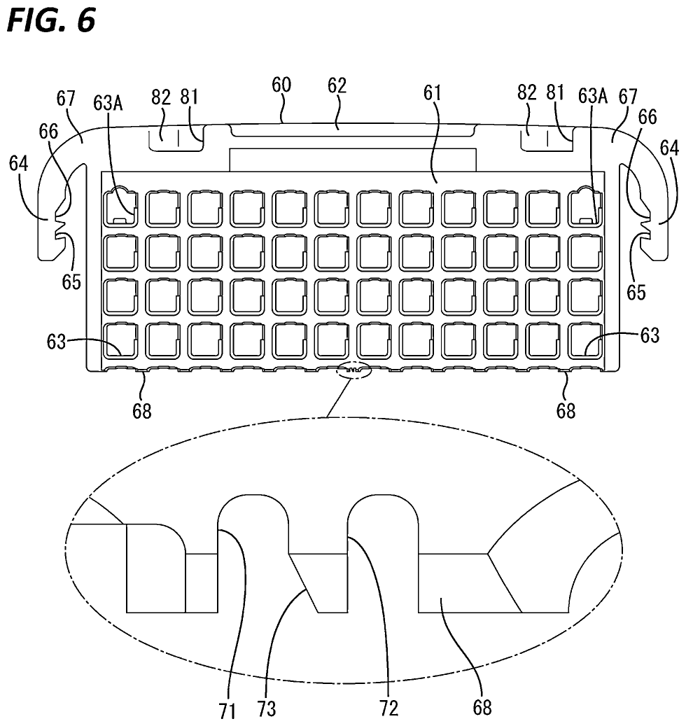

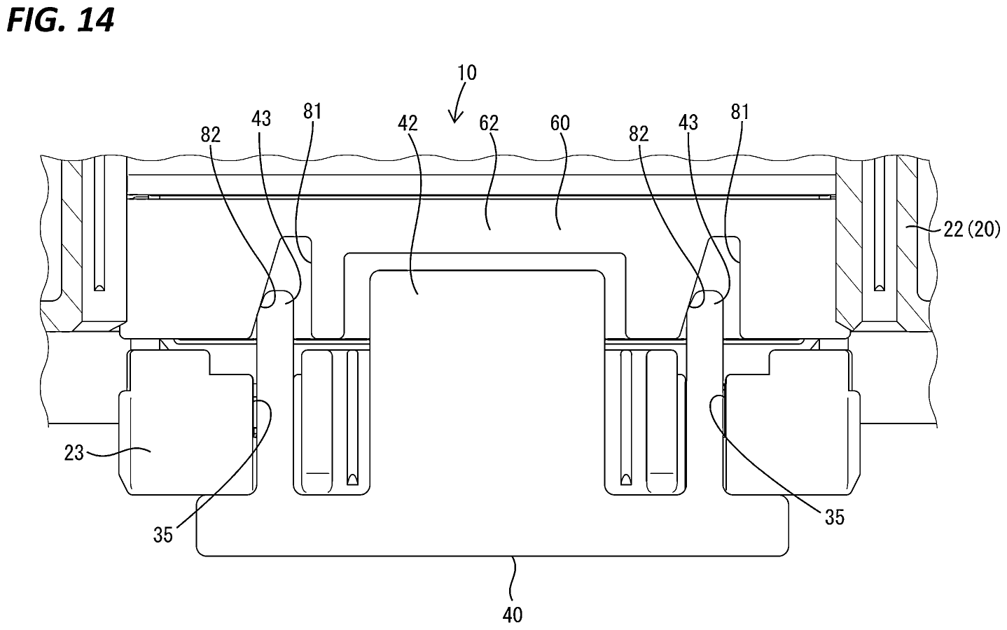

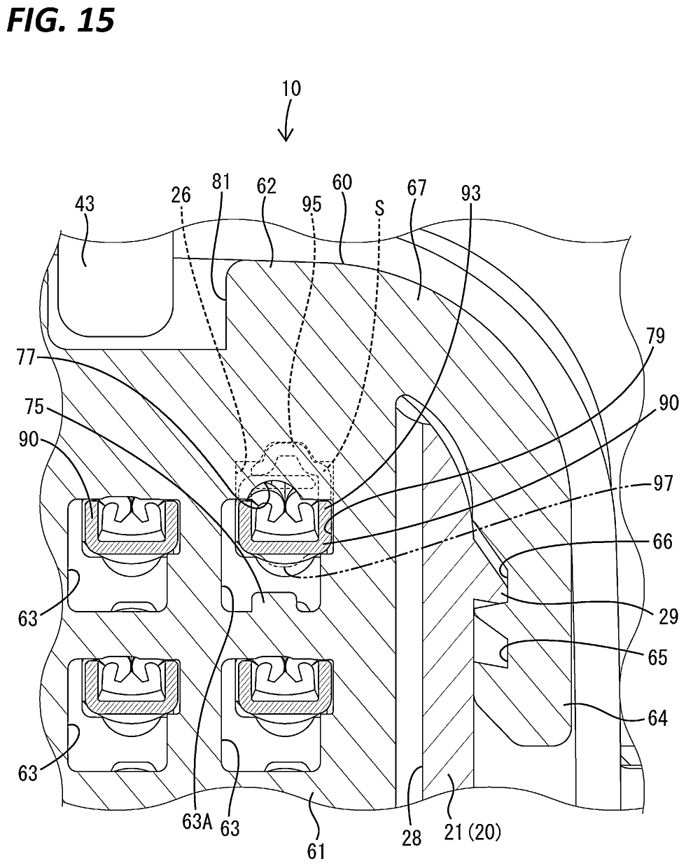

A connector 10 according to Embodiment 1 of the present disclosure includes a housing 20, a terminal fitting 90 configured to be accommodated in the housing 20, and a retainer 60 configured to be movably mounted to the housing 20. The housing 20 is configured to be fitted to a counterpart connector (not shown). In the following description, as for a front-rear direction, a direction in which the housing 20 is fitted to the counterpart connector is the front side. A vertical direction is defined in reference to the vertical directions in the drawings excluding FIGS. 13 and 14. A lateral direction is defined in reference to the lateral directions in FIGS. 6, 9, and 12 to 16. The references of the directions do not necessarily coincide with the references of the corresponding directions in a state in which the connector 10 is mounted in a vehicle (not shown). In FIG. 1, the front side is shown as the X direction, the right side is shown as the Y direction, and the upper side is shown as the Z direction.

### Overall Structure of Connector 10

More specifically, as shown in FIG. 1, the connector 10 includes an inner housing 21, an outer housing 22, a terminal fitting 90, a retainer 60, a front holder 23, a rubber ring 130, a one-piece rubber stopper 110, a lever 120, a cover (not shown). The inner housing 21, the outer housing 22, the retainer 60, the front holder 23, the lever 120, and the cover are made of synthetic resin. The terminal fitting 90 is made of metal. Th rubber ring 130 and the one-piece rubber stopper 110 are made of rubber such as silicone rubber.

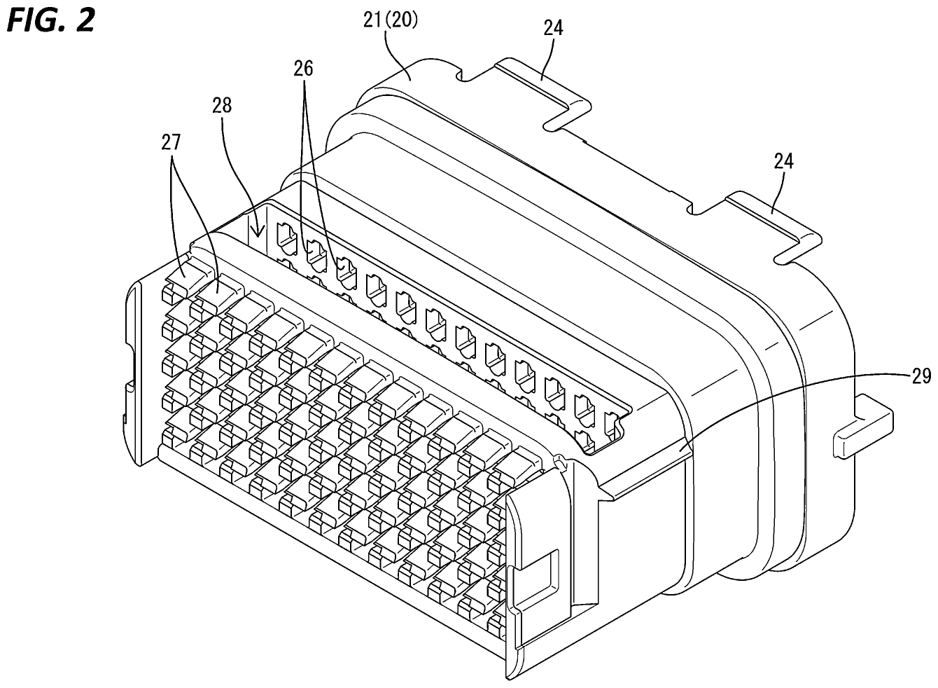

The outer housing 22 has a tubular shape and surrounds the entire outer circumference of the inner housing 21. A hood portion of a counterpart connector (not shown) can be fitted between the outer housing 22 and the inner housing 21. The outer housing 22 and the inner housing 21 are joined to each other via their respective coupling portions 24 (only the coupling portion 24 of the inner housing 21 is shown in FIG. 2), thus forming the housing 20 as a single piece.

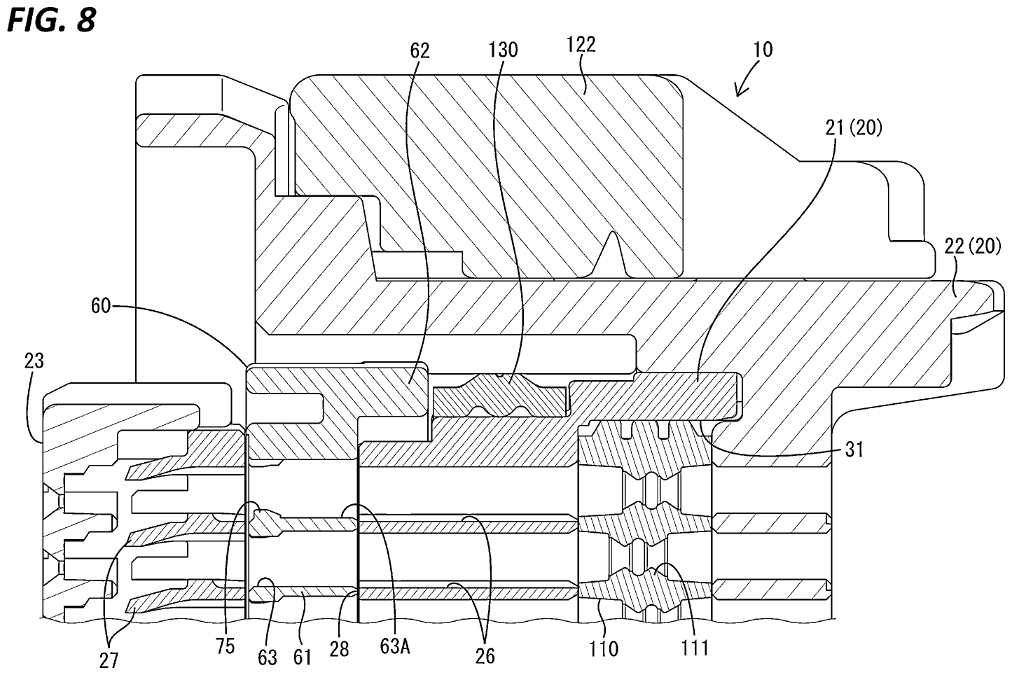

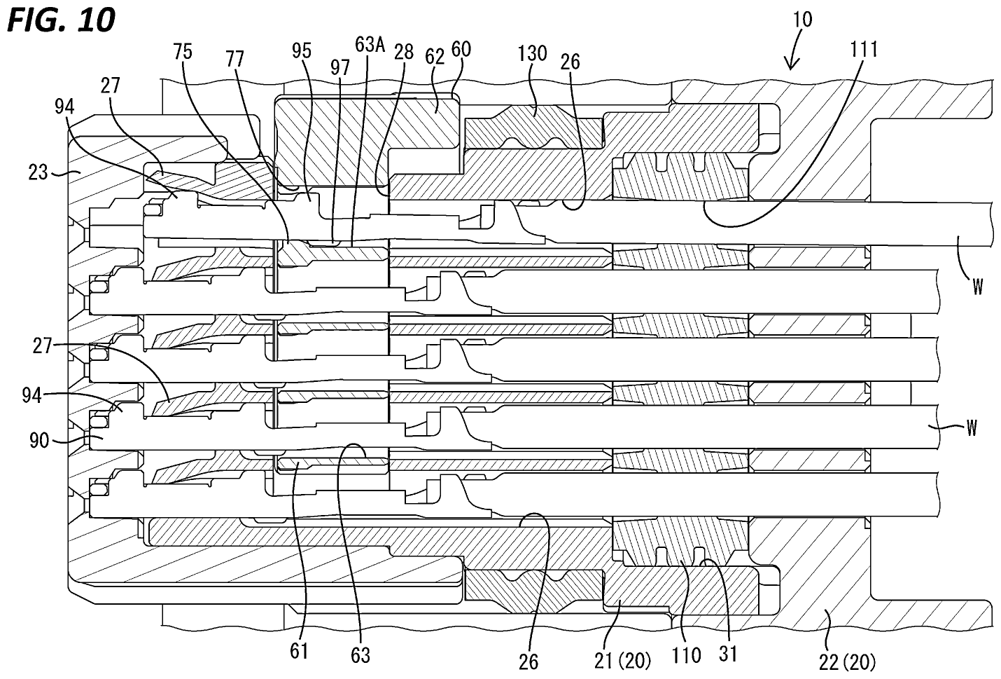

As shown in FIG. 2, the inner housing 21 has a rectangular block shape elongated in the lateral direction. The inner housing 21 has a plurality of cavities 26 extending therethrough in the front-rear direction. The cavities 26 are arranged in a plurality of columns in the vertical direction and a plurality of rows in the lateral direction. As shown in FIGS. 8 and 10, an elastically deformable lance 27 protrudes from the upper surface of the inner wall of each of the cavities 26. The terminal fitting 90 is inserted into each of the cavities 26 from the rear side. The terminal fitting 90 is locked to the lance 27, whereby dislodgement thereof from the cavity 26 is temporarily restricted.

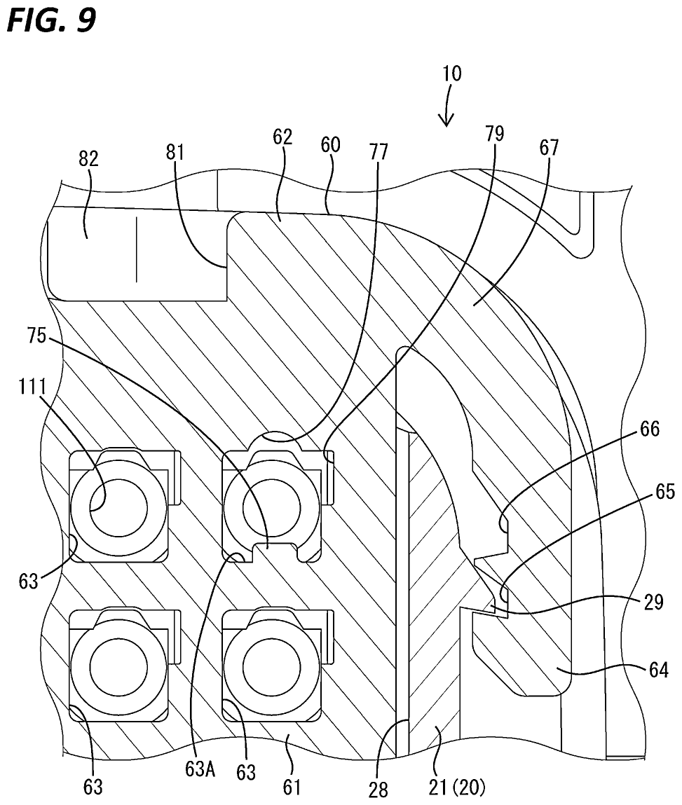

As shown in FIGS. 2 and 10, the inner housing 21 has a retainer mounting hole 28 extending in the vertical direction and open on the upper surface of the inner housing 21. Each of the cavities 26 is divided into front and rear sections inside the inner housing 21 with the retainer mounting hole 28 interposed therebetween. Each of the lances 27 is formed on the inner wall of the section of the corresponding cavity 26 that is located forward of the retainer mounting hole 28. As shown in FIG. 2, rib-shaped movement restricting portions 29 (only right side surface is shown in FIG. 2) extending in the front-rear direction are formed on left and right side surfaces of the inner housing 21. As shown in FIGS. 9, 12, and 15, the upper surface of the movement restricting portion 29 is inclined downward toward the outer side in the lateral direction. The lower surface of the movement restricting portion 29 is gently inclined downward toward the outer side in the lateral direction. As a result of being locked to the movement restricting portion 29, the retainer 60 is held in the housing 20 in a state in which the movement thereof is restricted.

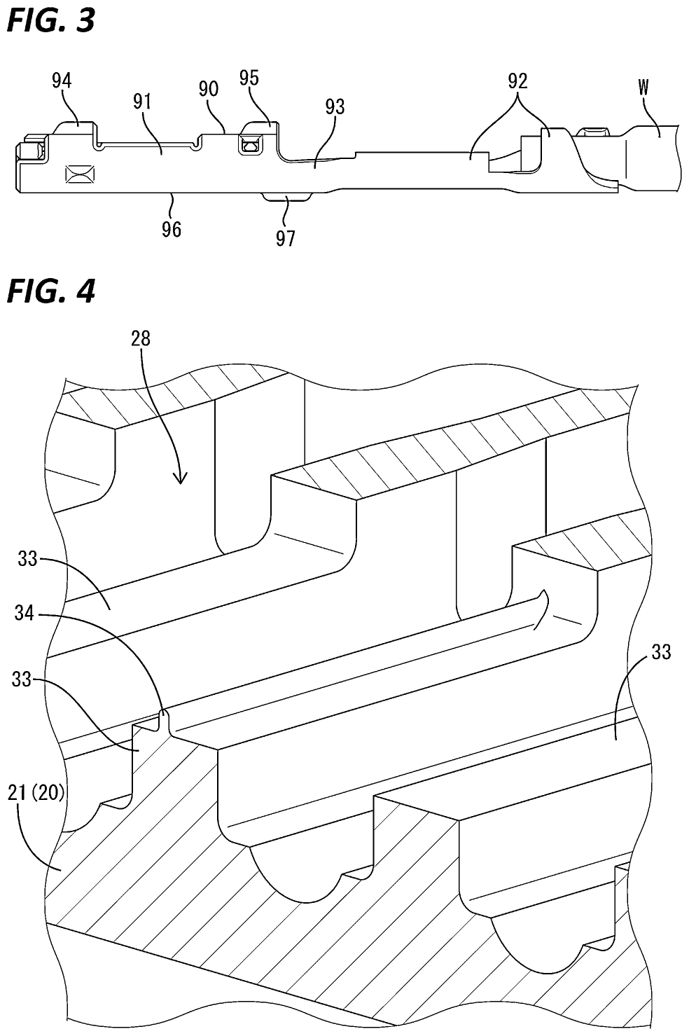

As shown in FIG. 3, the terminal fitting 90 has an overall shape that is elongated in the front-rear direction. The terminal fitting 90 includes a rectangular tubular connection portion 91, a barrel portion 92 located rearward of the connection portion 91, a joining portion 93 that is located between the connection portion 91 and the barrel portion 92 and joins the two portions. The barrel portion 92 is crimped to a terminal portion of a wire W, and is electrically and mechanically connected thereto. The connection portion 91 is electrically connected to a counterpart terminal fitting (male terminal fitting) (not shown) at the time of fitting the housing 20 and the counterpart connector.

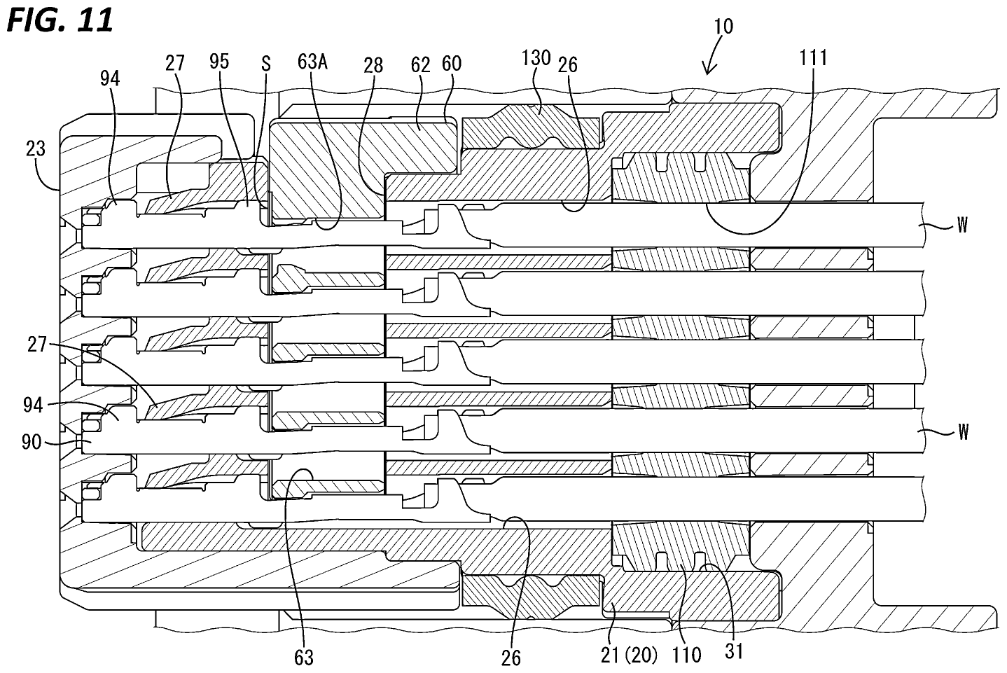

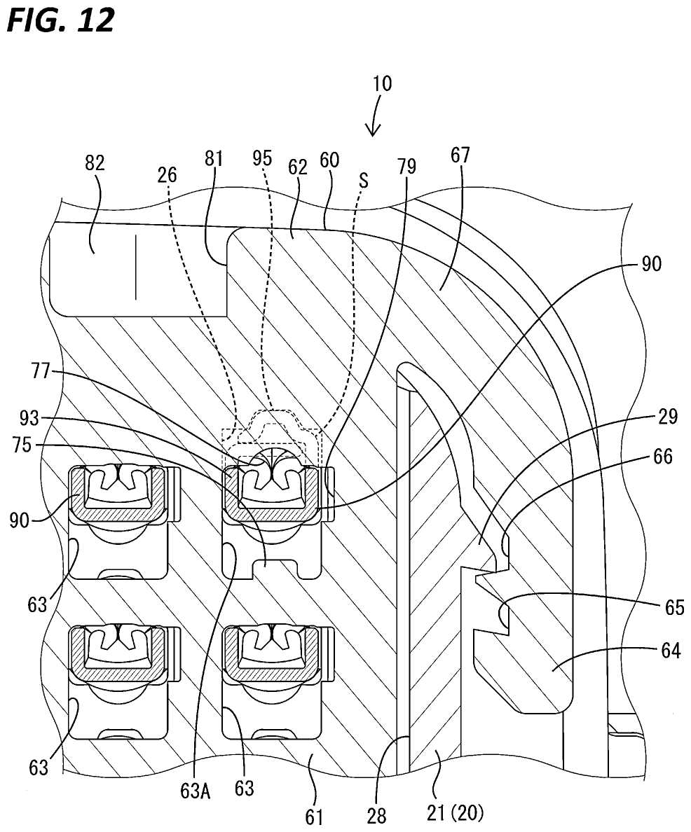

A lance locking portion 94 and a retainer locking portion 95 protrudes from the upper wall of the connection portion 91. The lance locking portion 94 is formed at a position toward a front end portion of the upper wall of the connection portion 91 by upwardly bending a part of the upper wall. Likewise, the retainer locking portion 95 is formed at a rear end portion of the upper wall of the connection portion 91 by upwardly bending a part of the upper wall. As shown in FIG. 11, the lance 27 can be locked to the lance locking portion 94. The retainer 60 can be locked to the retainer locking portion 95.

The retainer 60 is movable downward (toward one side in the vertical direction) from a partial locking position (see FIGS. 8 to 10) to a full locking position (see FIGS. 11 to 13) relative to the housing 20. Furthermore, in the case of Embodiment 1, the retainer 60 is movable leftward (toward the other side in the lateral direction) from the full locking position to a complete position (see FIGS. 14 to 16). As will be described below, the retainer 60 locks the terminal fitting 90 at the full locking position, and stabilizes the locking to the terminal fitting 90 at the complete position.

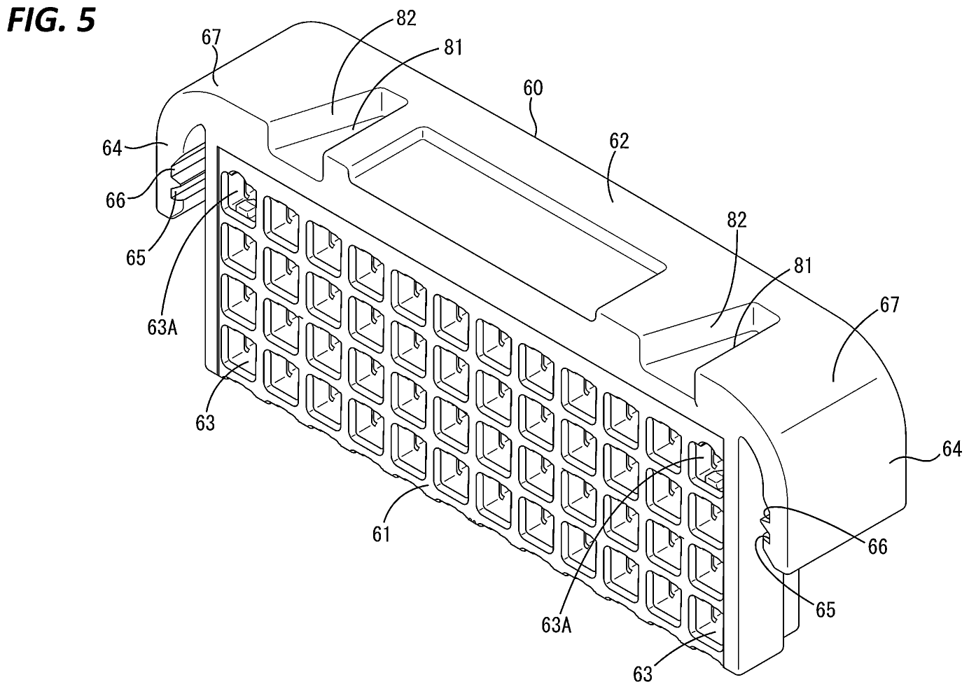

As shown in FIGS. 5 and 6, the retainer 60 includes a retainer body portion 61 having a rectangular outer shape in front view, and a covering portion 62 connected with an upper end portion of the retainer body portion 61. The retainer body portion 61 is inserted to be accommodated in the retainer mounting hole 28. The retainer body portion 61 has a plurality of insertion portions 63 extending through the retainer body portion 61 in the front-rear direction. The insertion portions 63 are arranged in a plurality of columns in the vertical direction and a plurality of rows in the lateral direction so as to correspond to the respective cavities 26 (except for the cavities 26 in the lowermost column).

As shown in FIG. 8, the covering portion 62 is connected with an upper end portion of the retainer body portion 61, and includes a portion projecting rearward of the retainer body portion 61. As shown in FIGS. 11, 12, and 15, the covering portion 62 covers and closes the upper opening of the retainer mounting hole 28 when the retainer 60 is at the full locking position and the complete position. As shown in FIGS. 5 and 6, a pair of housing lock portions 64 extending and bending downward are formed at left and right end portions of the covering portion 62. The housing lock portions 64 are opposed to the left and right side surfaces, respectively, of the retainer body portion 61 so as to be spaced apart therefrom. A first locking portion 65 and a second locking portion 66 are recessed on the inner side surface of each of the housing lock portions 64 in the lateral direction so as to be arranged in the vertical direction. The first locking portion 65 is disposed downward of the second locking portion 66. As shown in FIGS. 9, 12, and 15, the upper surface (the surface located on the upper side of the first locking portion 65 and facing downward) of the first locking portion 65 is inclined upward toward the inner side in the lateral direction. The lower surface (the surface located on the lower side of the first locking portion 65 and facing upward) of the first locking portion 65 is inclined upward toward the inner side in the lateral direction. The upper surface (the surface located on the upper side of the second locking portion 66 and facing downward) of the second locking portion 66 is inclined upward toward the inner side in the lateral direction. The lower surface (the surface located on the lower side of the second locking portion 66 and facing upward) of the second locking portion 66 is inclined downward toward the inner side in the lateral direction. Each of the housing lock portions 64 is elastically deformable in the lateral direction with a base portion 67 connected with an upper wall portion of the covering portion 62 as a fulcrum.

As shown in FIGS. 10 and 11, the front holder 23 is mounted to the inner housing 21 so as to cover the front surface of the inner housing 21. The rubber ring 130 is mounted to the outer circumferential surface of the inner housing 21. The rubber ring 130 is disposed in a compressed state between a hood portion of the counterpart connector and the inner housing 21 at the time of fitting the housing 20 and the counterpart connector. Thus, the housing 20 and the counterpart connector are sealed. The rubber ring 130 is disposed adjacent to the covering portion 62 at a position rearward of the retainer 60.

As shown in FIGS. 8, 10, and 11, the one-piece rubber stopper 110 is accommodated in an accommodating recess 31 that is open on the rear surface of the inner housing 21. The one-piece rubber stopper 110 accommodated in the accommodating recess 31 is restricted from being dislodged rearward by the back wall of the outer housing 22. The outer circumferential surface of the one-piece rubber stopper 110 is in intimate contact with the inner circumferential surface of the accommodating recess 31 in a liquid-tight manner. The one-piece rubber stopper 110 has a plurality of seal holes 111 extending therethrough in the front-rear direction. A wire W connected to the terminal fitting 90 is inserted through each of the seal holes 111 in a liquid-tight manner. Thus, the interior of the cavities 26 is sealed.

As shown in FIG. 1, the lever 120 includes an operation portion 121 extending in the vertical direction, and a pair of arm portions 122 protruding from upper and lower end portions, respectively, of the operation portion 121 so as to be opposed to each other. The arm portions 122 are rotatably supported by support shafts 32 formed on the upper wall and the lower wall, respectively, of the outer housing 22 (only the support shaft 32 formed on the upper wall is shown in FIG. 1). The lever 120 is rotatable about the support shaft 32 between an initial position and a fitting position relative to the housing 20. The arm portions 122 are engaged with the counterpart connector when the lever 120 is at the initial position, and are rotated in that states from the initial position toward the fitting position. Thus, the counterpart connector is drawn toward the housing 20, whereby fitting between the housing 20 and the counterpart connector proceeds with a low fitting force. The cover (not shown) is attached to the outer housing 22 from the rear side. The cover covers the wires W extending from the rear surface of the inner housing 21, and defines the lead-out direction of the wires W.

### Detailed Structure of Terminal Fitting 90, Inner Housing 21, and Retainer 60

As shown in FIG. 3, the terminal fitting 90 has a base wall 96 serving as a bottom plate portion extending across the entire length in the front-rear direction. A pressing portion 97 protrudes from the base wall 96. The pressing portion 97 has the function of pressing a pressed insertion portion 63A, which will be described below, thereby moving the retainer 60 from the partial locking position to the full locking position. The pressing portion 97 has a rib shape formed by downwardly bulging a lateral central portion of the base wall 96, and is elongated in the front-rear direction. The front surface of the pressing portion 97 is inclined rearward toward the lower side. The front surface of the pressing portion 97 is disposed at a position overlapping a rear end portion of the connection portion 91 in the front-rear direction. The lower surface of the pressing portion 97 is disposed along the front-rear direction. The rear surface of the pressing portion 97 is inclined forward toward the lower side. The rear surface of the pressing portion 97 is disposed at a position overlapping the joining portion 93 in the front-rear direction.

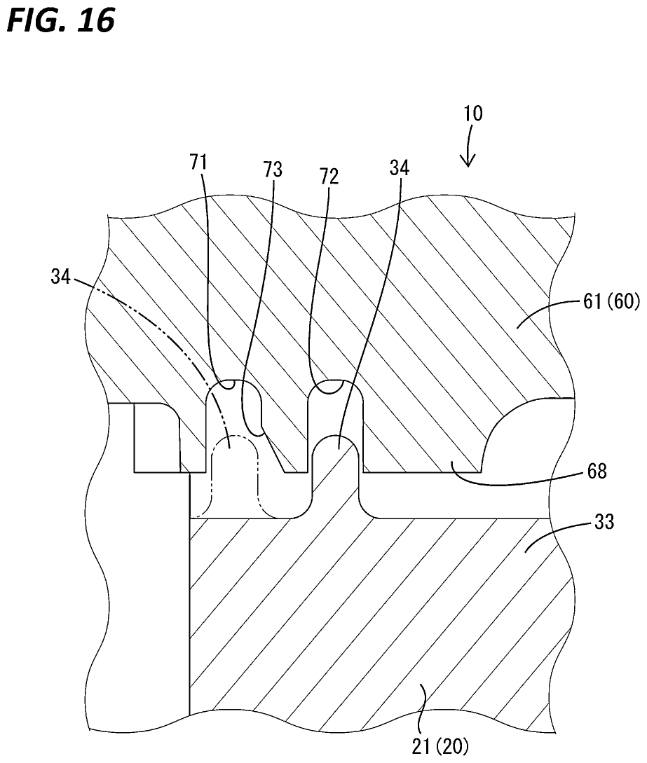

The inner housing 21 includes, between itself and the lower end of the retainer 60 located at the full locking position and the complete position, a plurality of partition wall portions 33 forming portions communicating with the respective cavities 26 in the lowermost column (portions corresponding to the insertion portions in the lowermost column). As shown in FIG. 4, the partition wall portions 33 protrude from the bottom surface of the retainer mounting hole 28 of the inner housing 21 so as to be arranged in the lateral direction. Of the partition wall portions 33, the partition wall portion 33 located at a lateral central portion of the inner housing 21 has a stopper portion 34 formed thereon. The stopper portion 34 has a rib shape extending in the front-rear direction, and protrudes from a lateral central portion of the upper end face of the partition wall portion 33. As shown in FIG. 16, a full locking receiving portion 71 and a complete receiving portion 72, which will be described below, of the retainer 60 can be locked to the stopper portion 34.

As shown in FIG. 6, the retainer 60 includes a plurality of protruding wall portions 68 that are arranged on the lower surface of the retainer body portion 61 in the lateral direction. When the retainer 60 is at the full locking position and the complete position, the partition wall portions 33 and the corresponding protruding wall portions 68 are opposed to each other so as to be capable of coming into contact with each other. The portions corresponding to the insertion portions in the lowermost column are defined between the partition wall portions 33 and the corresponding protruding wall portions 68. Of the protruding wall portions 68, the protruding wall portion 68 located at a lateral central portion of the retainer 60 has a full locking receiving portion 71 and a complete receiving portion 72 formed thereon. The full locking receiving portion 71 and the complete receiving portion 72 each have a groove shape extending in the front-rear direction, and are recessed in the lower end face of the protruding wall portion 68 so as to be arranged in the lateral direction. As a result of a distal end portion of the stopper portion 34 being fitted and locked to the full locking receiving portion 71, positional displacement in the lateral direction of the retainer 60 at the full locking position is restricted. As a result of the distal end portion of the stopper portion 34 being fitted and locked to the complete receiving portion 72, positional displacement in the lateral direction of the retainer 60 at the complete position is restricted (see FIG. 16). A tapered cut-out portion 73 for allowing the stopper portion 34 to easily move from the full locking receiving portion 71 to the complete receiving portion 72 is formed at a side corner portion of the full locking receiving portion 71 that is located on the other side in the lateral direction (the right side in FIG. 6).

As shown in FIGS. 5 and 6, some of the insertion portions 63 are configured as pressed insertion portions 63A. The pressing portion 97 of the terminal fitting 90 is opposed to an inner surface (a lower inner surface portion 74 described below) of each of the pressed insertion portions 63A, and the pressed insertion portions 63A is pressed downward (toward one side in the vertical direction) by the pressing portion 97. The pressed insertion portions 63A are formed by the insertion portions 63 located at left and right end portions among the insertion portions 63 arranged in a plurality of rows in the lateral direction. Also, the pressed insertion portions 63A are formed by the insertion portions 63 located on the uppermost side (the other side in the vertical direction) among the insertion portions 63 arranged in a plurality of columns in the vertical direction. That is, the pressed insertion portions 63A are formed by the insertion portions 63 located at left and right end portions and upper end portions among the insertion portions 63. Also, the pressed insertion portions 63A are disposed at the positions closest to the corresponding housing lock portions 64 among the insertion portion 63. Of the insertion portions 63, the insertion portions 63 other than the pressed insertion portions 63A are formed as normal insertion portions 63 that are not pressed by the pressing portion 97 of the terminal fitting 90.

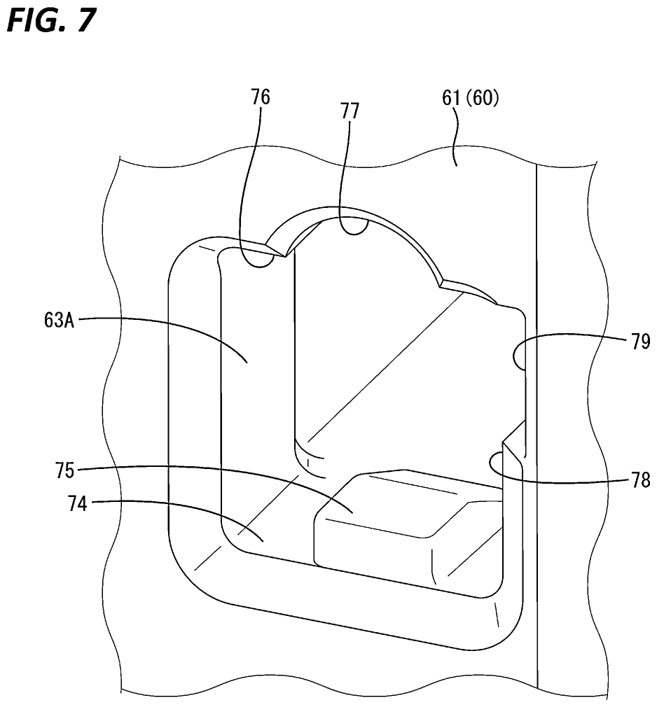

As shown in FIG. 7, each of the pressed insertion portions 63A includes a pressed protrusion 75 having a shape protruding upward (toward the other side in the vertical direction) on a lower inner surface portion 74 located on the lower side (one side in the vertical direction) among upper and lower inner surface portions disposed opposed each other in the vertical direction and disposed along the lateral direction. The pressed protrusion 75 protrudes from a lateral central portion of the lower inner surface portion 74. The pressed protrusion 75 has a flat trapezoidal shape. The front surface of the pressed protrusion 75 faces the front opening of the pressed insertion portion 63A, and is disposed along the lateral direction and the vertical direction. The upper surface (front end surface in the protruding direction) of the pressed protrusion 75 is disposed flat along the lateral direction and the front-rear direction. The rear surface of the pressed protrusion 75 is inclined upward toward the front side. When the terminal fitting 90 passes through the interior of the pressed insertion portion 63A, the pressing portion 97 slidably comes into contact with the pressed protrusion 75 from the rear surface to the upper surface thereof.

As shown in FIG. 7, each of the pressed insertion portions 63A includes a recess 77 having a shape recessed upward (toward the other side in the vertical direction) on an upper inner surface portion 76 located on the upper side (the other side in the vertical direction) among upper and lower inner surface portions. The recess 77 is recessed at a lateral central portion of the upper inner surface portion 76. The recess 77 has the shape of a curved recess in front view, and is open at an upper edge portion of the front opening of the pressed insertion portion 63A. When the pressing portion 97 rides on the pressed protrusion 75 while the terminal fitting 90 passes through the interior of the pressed insertion portion 63A, the retainer locking portion 95 enters the recess 77 for escape.

Furthermore, each of the pressed insertion portions 63A includes a side recess 79 having a shape recessed toward one side in the lateral direction on one-side inner surface portion 78 located on the other side (the right side in FIG. 7) that is included in left and right inner surface portions opposed to each other in the lateral direction and disposed along the vertical direction. The side recess 79 is recessed at an upper end portion of the one-side inner surface portion 78. The side recess 79 has the shape of a square recess elongated in the vertical direction in front view, and is open at one side edge of the front opening of the pressed insertion portion 63A. As shown in FIG. 15, when the retainer 60 is at the complete position, one side wall (right side wall) of the joining portion 93 of the terminal fitting 90 enters the side recess 79 for escape.

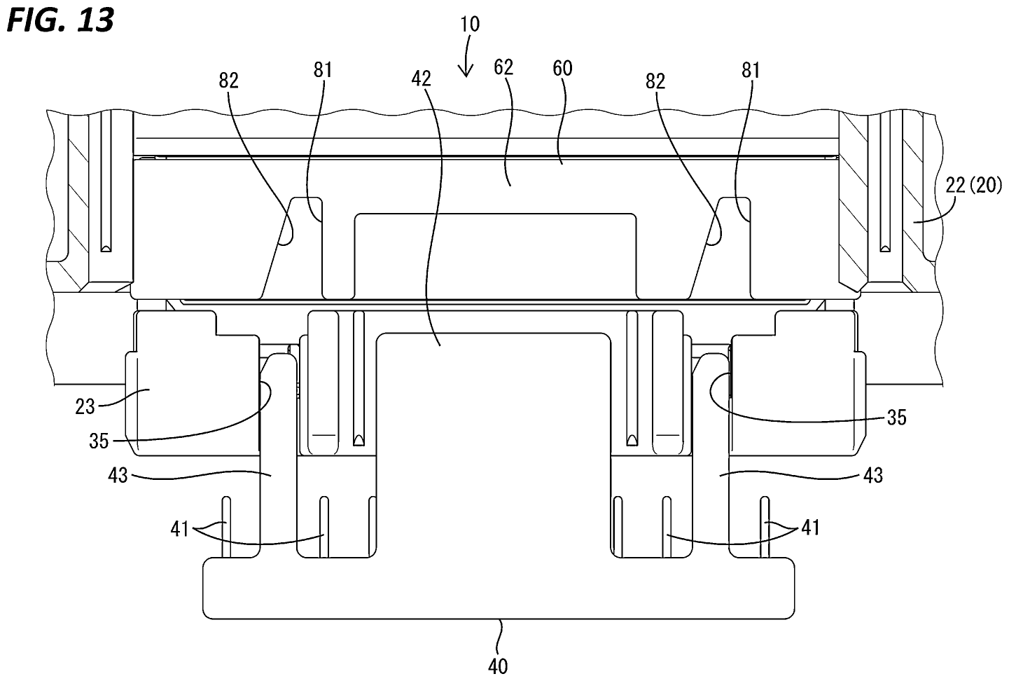

Of the front surface of the retainer body portion 61, a part opposed to the retainer locking portion 95 of the terminal fitting 90 when the retainer 60 is at the full locking position and the complete position is formed as a locking range S (the range defined by the broken line extending along the shape of the terminal fitting 90 in FIGS. 12 and 15) that can be locked to the terminal fitting 90. The locking range S is formed at an upper opening edge portion of each of the insertion portions 63 on the front surface of the retainer body portion 61. For each of the pressed insertion portions 63A, the locking range S is configured to expand and increase toward one side in the lateral direction of the recess 77 as a result of the retainer 60 being moved from the full locking position to the complete position.

As shown in FIG. 5, the retainer 60 includes a pair of recessed grooves 81 disposed so as to be spaced apart on left and right sides of the upper surface of the covering portion 62. Each of the recessed grooves 81 extends in the front-rear direction and is open on the front end face of the covering portion 62. Of the groove surface of each of the recessed grooves 81, the side surface located on one side (the left side in FIG. 5) in the lateral direction is formed as a cam portion 82 that can be fitted to a jig 40, which will be described below. The cam portion 82 has a shape that is inclined toward the other side (the right side in FIG. 5) in the lateral direction from the front end face (the surface that is open forward) of the covering portion 62 as the cam portion 82 extends rearward.

### Operation of Connector 10

In a state in which the retainer 60 is disposed at the partial locking position relative to the housing 20, the retainer body portion 61 is inserted into the retainer mounting hole 28, and the covering portion 62 is disposed so as to be lifted above the upper surface of the inner housing 21, as shown in FIG. 8. The insertion portions 63 are disposed so as to communicate with the corresponding cavities 26 in the front-rear direction. In the interior of each of the insertion portions 63, a path through which the terminal fitting 90 can be inserted is secured. Each of the pressed insertion portions 63A allows the pressed protrusion 75 to be disposed at a position at which the pressed protrusion 75 can interfere with the pressing portion 97 while securing the path. At the partial locking position, as shown in FIG. 9, the movement restricting portions 29 of the inner housing 21 are fitted into the first locking portions 65 of the corresponding housing lock portions 64, whereby the retainer 60 is held in a state in which the movement thereof to the partial locking position relative to the housing 20 is restricted.

When the retainer 60 is at the partial locking position, the terminal fitting 90 connected to the terminal portion of the wire W is inserted into a cavity 26 of the corresponding housing 20 from the rear side. In the case of Embodiment 1, the terminal fittings 90 are successively inserted into the cavities 26 in the columns in the vertical direction by an automated machine or the like (not shown), from the bottom to the top column. After each of the terminal fittings 90 has been inserted into the corresponding cavity 26 to a proper depth, the lance locking portion 94 is disposed so as to be fitted to the lance 27, whereby dislodgement of the terminal fitting 90 from the cavity 26 is primarily restricted.

As shown in FIG. 9, when the terminal fitting 90 in the uppermost column is inserted into the corresponding cavity 26, and the connection portion 91 is to pass through the interior of the pressed insertion portion 63A from the cavity 26 located on the rear side, the front surface of the pressing portion 97 comes into contact with the rear surface of the pressed protrusion 75. As a result of the inclined contact between the front surface of the pressing portion 97 and the rear surface of the pressed protrusion 75, the pressing force (operating force) pushing the terminal fitting 90 forward is partially transformed into the pressing force moving the retainer 60 downward (toward one side in the vertical direction). The first locking portion 65 of the housing lock portion 64 that has received the downward pressing force is moved away from the movement restricting portion 29, to release the locking between the first locking portion 65 and the movement restricting portion 29, and the retainer 60 is moved from the partial locking position to the full locking position along with return movement of the housing lock portion 64.

When the connection portion 91 is displaced upward relative to the retainer 60 due to the downward movement of the retainer 60, the retainer locking portion 95 enters the recess 77. This prevents interference between the retainer locking portion 95 and the retainer body portion 61. Thereafter, the connection portion 91 is deeply inserted into the cavity 26 on the front side, and the pressing portion 97 rides on the pressed protrusion 75, whereby the lower surface of the pressing portion 97 comes into contact with the upper surface of the pressed protrusion 75. While the pressing portion 97 rides on the pressed protrusion 75, the movement of the retainer 60 toward the full locking position is continued, and the retainer 60 can automatically reach the full locking position after the pressing portion 97 has ridden on the pressed protrusion 75.

As shown in FIG. 11, at the full locking position, the retainer 60 is opposed to the retainer locking portion 95 of the terminal fitting 90 so as to be locked thereto, whereby dislodgement of the terminal fitting 90 from the cavity 26 is secondarily restricted. Then, as shown in FIG. 12, the movement restricting portion 29 of the inner housing 21 is fitted into the second locking portion 66 of the housing lock portion 64, and a distal end portion of the stopper portion 34 is fitted into the full locking receiving portion 71 (see the dashed double-dotted line in FIG. 16), whereby the retainer 60 is held in a state in which the movement thereof to the full locking position relative to the housing 20 is restricted is restricted.

As shown in FIG. 12, at the full locking position, the lateral center of the locking range S of the retainer 60 and the lateral center of the recess 77 of the pressed insertion portion 63A coincide or substantially coincide with each other. Accordingly, the shear area of the retainer 60 for the terminal fitting 90 may be reduced by the recess 77, and the stability of the locking to the terminal fitting 90 may not be ensured. In contrast, in the case of Embodiment 1, the stability of the locking can be ensured such that the locking range S of the retainer 60 is positionally displaced from the center of the recess 77 of the pressed insertion portion 63A by the retainer 60 moving from the full locking position to the complete position relative to the housing 20, as shown in FIG. 15.

There is no need to use a dedicated jig for moving the retainer 60 to the complete position, and it is possible to use, for example, a jig for testing the conduction state of the terminal fitting 90, and a jig for testing the semi-inserted state of the retainer 60. As shown in FIG. 13, Embodiment 1 uses a dual purpose jig 40 including probe pins 41 for detecting the conduction state of the terminal fittings 90, and also including a semi-insertion detection portion 42 for detecting the semi-inserted state of the retainer 60 relative to the housing 20. The probe pins 41 are disposed at positions corresponding to the respective terminal fittings 90 so as to be able to come into individual contact with the respective terminal fittings 90. In order to be able to detect the semi-inserted state (protruding state or the lifting state from the upper surface of the inner housing 21) of the retainer 60, the semi-insertion detection portion 42 is disposed at a height position at which the semi-insertion detection portion 42 can interfere with the retainer 60 in the semi-inserted state, and is formed in a plate shape. Also, the jig 40 includes a pair of cam engaging portions 43 on left and right sides with the semi-insertion detection portion 42 interposed therebetween, and at the same height position as the semi-insertion detection portion 42. Similarly to the semi-insertion detection portion 42, the cam engaging portions 43 have the function of detecting the semi-inserted state of the retainer 60.

As shown in FIG. 13, in a state in which the retainer 60 is disposed at the full locking position relative to the housing 20, the jig 40 is mounted to the connector 10 (more specifically, the interior of the outer housing 22) from the front side. The mounting of the jig 40 is guided by the cam engaging portions 43 being displaced along groove portions 35 formed on the upper surface of the front holder 23. Then, as shown in FIG. 14, the distal end portions of the cam engaging portions 43 enter the respective recessed grooves 81 and are displaced along the cam portions 82, whereby the retainer 60 can be moved to the other side in the lateral direction, and the stopper portion 34 can ride over the cut-out portion 73 to reach the complete position. As shown in FIG. 16, at the complete position, the distal end portion of the stopper portion 34 is fitted into the complete receiving portion 72, whereby positional displacement of the retainer 60 in the lateral direction is restricted. As shown in FIG. 15, a state in which each of the second locking portions 66 can be locked to the corresponding movement restricting portion 29 is maintained, whereby positional displacement of the retainer 60 in the vertical direction is also restricted.

As a result of the retainer 60 being moved from the full locking position to the complete position in this manner, the retainer 60 is shifted toward one side in the lateral direction relative to the housing 20, and the locking range S of the retainer 60 relative to each of the terminal fittings 90 is significantly expanded toward one side of the recess 77 in the lateral direction (see FIG. 15). This makes it possible to increase the shear area of the retainer 60 to the terminal fitting 90, thus ensuring the stability of locking to the terminal fitting 90.

As described thus far, the connector 10 according to Embodiment 1 includes a housing 20 having cavities 26 extending in the front-rear direction, terminal fittings 90 accommodated in the respective cavities 26, and a retainer 60 movable downward (toward one side in the vertical direction) from the partial locking position to the full locking position housing 20. The retainer 60 includes insertion portions 63 through which the terminal fittings 90 are insertable, and is configured to allow the terminal fittings 90 to pass through the insertion portions 63 at the partial locking position, and restrict dislodgement of the terminal fittings 90 from the cavities 26 at the full locking position. Each of the terminal fittings 90 has a pressing portion 97 formed thereon. The insertion portions 63 include pressed insertion portions 63A configured to be pressed downward by the pressing portion 97 at the partial locking position, and allow movement of the retainer 60 to the full locking position.

With the above-described configuration of Embodiment 1, when the retainer 60 is at the partial locking position, and the connection portions 91 of the terminal fittings 90 are to pass through the pressed insertion portions 63A, the pressing portions 97 press the pressed insertion portions 63A, and the retainer 60 can be moved from the partial locking position to the full locking position. Accordingly, the retainer 60 can be automatically moved to the full locking position, in conjunction with an operation for inserting the terminal fittings 90 into the housing 20.

In the case of Embodiment 1, the retainer 60 includes housing lock portions 64 configured to be locked to the housing 20 at the partial locking position. The pressed insertion portions 63A are formed by the insertion portions 63 located closest to the corresponding housing lock portion 64 among the plurality of insertion portions 63. With this configuration, the pressing force with which the pressing portions 97 press the pressed insertion portions 63A is effectively transmitted to the housing lock portions 64, and therefore the locking between the housing lock portions 64 and the housing 20 at the partial locking position can be easily released.

In the case of Embodiment 1, the pressed insertion portions 63A are formed by the insertion portions 63 located at an upper end portion (the other end portion in the vertical direction) among the plurality of insertion portions 63 arranged in the vertical direction. With this configuration, when successively inserting the terminal fittings 90 from the cavities 26 in the bottom column to the cavities 26 in the top column, and inserting the terminal fittings 90 into the cavities 26 located at the upper end portion, the pressed insertion portions 63A can be pressed downward by the pressing portions 97 of the terminal fittings 90, thus easily moving the retainer 60 to the full locking position.

In the case of Embodiment 1, the pressed insertion portions 63A are formed by the insertion portions 63 located at left and right end portions among the plurality of insertion portions 63 arranged in the lateral direction. With this configuration, the pressing force exerted from the pressing portions 97 to the retainer 60 is exerted in a well-balanced manner on the pressed insertion portions 63A located at left and right end portions of the retainer 60, and therefore the retainer 60 can be smoothly moved to the full locking position without being inclined.

In the case of Embodiment 1, a pressed protrusion 75 capable of coming into contact with the pressing portion 97 is formed on a lower inner surface portion 74 of an inner surface of each of the pressed insertion portions 63A that is located on the lower side, and a recess 77 is formed on an upper inner surface portion 76 located on the upper side. With this configuration, when the retainer 60 is moved to the full locking position, the pressing portions 97 of the terminal fittings 90 press the pressed protrusions 75 of the pressed insertion portions 63A. Accordingly, the pressing force exerted from the pressing portions 97 on the retainer 60 can be adjusted by adjusting the protruding dimension and the shape of the pressed protrusions 75. Even if any of the pressing portions 97 comes into contact with the pressed protrusion 75, and the terminal fitting 90 is displaced upward, i.e., toward the side where the pressing portion 97 rides on the pressed protrusion 75, the retainer locking portion 95 of the displaced terminal fittings 90 can escape into the recess 77. Accordingly, it is possible to prevent the terminal fitting 90 from coming into contact with the retainer 60.

In the case of Embodiment 1, in order for the locking range S of the retainer 60 relative to each of the terminal fittings 90 to be expanded toward one side of the recess 77 in the lateral direction, the retainer 60 is disposed movable toward the other side in the lateral direction from the full locking position to the complete position relative to the housing 20. With this configuration, the terminal fittings 90 can be locked to the retainer 60 in a stable locking state at the complete position by the retainer 60 being moved from the full locking position to the complete position.

Furthermore, in the case of Embodiment 1, the housing 20 includes cam portions 82 that allow movement of the retainer 60 to the complete position. Each of the cam portions 82 extending the front-rear direction, and has a shape that is open forward and is inclined toward the other side in the lateral direction as the cam portion 82 extends rearward. With this configuration, in the process in which a jig 40 used for a conduction test or the like is mounted to the housing 20 from the front side, the distal end portion of the jig 40 is displaced along the cam portion 82, whereby the retainer 60 can be moved from the full locking position to the complete position. Accordingly, it is not necessary to perform any special operation for moving the retainer 60 to the complete position, thus ensuring an improvement in the operability.

### Other Embodiments of the Present Disclosure

It should be appreciated that Embodiment 1 presently disclosed is in all respects illustrative and not limiting.

In the case of Embodiment 1 described above, some of the plurality of insertion portions 63 are formed as the pressed insertion portions 63A. In contrast, according to other embodiments, all of the plurality of insertion portions may be formed as the pressed insertion portions. When the housing has only one insertion portion formed therein, the one insertion portion may also be formed as the pressed insertion portion.

In the case of Embodiment 1 described above, the retainer 60 is configured to be moved downward from the partial locking position to the full locking position, and be moved leftward from the full locking position to the complete position, relative to the housing 20. In contrast, according to other embodiments, the retainer may also be configured to be moved upward from the partial locking position to the full locking position, or may also be configured to be moved rightward from the full locking position to the complete position, relative to the housing.

In the case of Embodiment 1 described above, the retainer 60 is movable between the partial locking position and the full locking position, and is also movable between the full locking position and the complete position, relative to the housing 20. In contrast, according to other embodiments, it is also possible to adopt a configuration in which the retainer is movable between the partial locking position and the full locking position, but is not moved between the full locking position and the complete position, relative to the housing.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting with the true scope and spirit being indicated by the following claims.

What is claimed is:

1. A connector comprising:
a housing having a cavity extending in a front-rear direction;
a terminal fitting configured to be accommodated in the cavity; and
a retainer movable toward one side in a vertical direction from a partial locking position to a full locking position relative to the housing, wherein
the retainer includes at least one insertion portion through which the terminal fitting is insertable, and configured to allow passage of the terminal fitting through the at least one insertion portion at the partial locking position, and restrict dislodgement of the terminal fitting from the cavity at the full locking position,
the terminal fitting has a pressing portion formed thereon, and
the at least one insertion portion includes at least one pressed insertion portion configured to be pressed toward the one side in the vertical direction by the pressing portion at the partial locking position, to move the retainer to the full locking position.

2. The connector according to claim 1, wherein
the retainer includes a housing lock portion configured to be locked to the housing at the partial locking position,
a plurality of the insertion portions are formed in the retainer, and
the at least one pressed insertion portion is constituted by the insertion portion located closest to the housing lock portion, among the plurality of the insertion portions.

3. The connector according to claim 1, wherein
a plurality of the insertion portions are formed in the retainer so as to be arranged in the vertical direction, and
the at least one pressed insertion portion is constituted by the insertion portion located at an end portion on another side in the vertical direction, among the plurality of the insertion portions.

4. The connector according to claim 1, wherein
a plurality of the insertion portions are formed in the retainer so as to be arranged in a lateral direction, and
the at least one pressed insertion portion is constituted by the insertion portions located at left and right end portions, among the plurality of the insertion portions.

5. The connector according to claim 1, wherein,
on an inner surface portion, located on the one side in the vertical direction, of an inner surface of the at least one pressed insertion portion, a pressed protrusion protruding toward another side in the vertical direction and configured to come into contact with the pressing portion is formed, and,
on an inner surface portion, located on the other side in the vertical direction, of the inner surface of the at least one pressed insertion portion, a recess that is recessed toward the other side in the vertical direction is formed.

6. The connector according to claim 5, wherein
in order for a locking range of the retainer relative to the terminal fitting to be expanded toward one side of the recess in a lateral direction, the retainer is movable toward another side in the lateral direction from the full locking position to the complete position relative to the housing.

7. The connector according to claim 6, wherein
the housing includes a cam portion for moving the retainer to the complete position, and the cam portion extends in the front-rear direction, and has a shape that is open forward and is inclined toward the other side in the lateral direction as the cam portion extends rearward.
